(19) United States
(12) Patent Application Publication
(10) Pub. No.: US 2009/0273705 A1
(43) Pub. Date: Nov. 5, 2009

(54) Television Broadcast Display Apparatus

(76) Inventors: Nozomu Matsumoto, Tokyo-to (JP); Hideki Hoshino, Kanagawa-ken (JP)

Correspondence Address: CARR & FERRELL LLP, 2200 GENG ROAD, PALO ALTO, CA, 94303, US

(21) Appl. No.: 12/344,055

(22) Filed: Dec. 24, 2008

(30) Foreign Application Priority Data
May 1, 2008 (JP) JP2008-120019

(51) Int. Cl. H04N 5/66

(52) U.S. Cl. 348/383; 348/E05.133

(57) ABSTRACT

In a television broadcast display apparatus, a mobile device is configured so that images can be displayed on a second screen when audio signals are outputted from the mobile device. A control unit switches between television output status and mobile device output status according to a user operation inputted to a remote-control transmitter. The mobile device output status is a state where audio corresponding to the audio signals received from the mobile device attached is output from speakers. A mobile device holder supports the attached mobile device detachably in such a position that when a user views from an expected viewpoint where a first screen is visible, the second screen is also visible, and the second screen is located adjacent to the first screen.

### CROSS-REFERENCE TO RELATED APPLICATIONS

This application claims the priority benefit of Japanese patent application number 2008-120019 filed May 1, 2008, the disclosure of which is incorporated herein by reference.

### BACKGROUND OF THE INVENTION

1. Field of the Invention

The present invention relates to a television broadcast display apparatus and, in particular, to a television broadcast display apparatus for displaying images corresponding to received television broadcast signals.

2. Description of the Related Art

Today, mobile devices are capable of reproducing music and/or images at an outside location away from home; an example being portable digital audio players that are being actively developed. Proposed to support wider use of such mobile devices are, for instance, various mobile device support equipment that can capture the images on the display of the mobile devices, convert them into television signal waves, and transmit like that found in Japanese Patent Application Publication No. 2007-129546.

Today, many of the mobile devices capable of playing back music are provided with liquid crystal or other displays, which display images, the state of audio playback, and the like. In such a case, when a mobile device is used connected to a television broadcast display apparatus that outputs images and sounds corresponding to television broadcast signals, the screen of the television broadcast display apparatus and the display screen of the mobile device coexist with each other. And technology such as disclosed in Japanese Patent Application Publication No. 2007-129546 is such that when the images on the display screen of a mobile device are being displayed, it is difficult to display other information on the display screen of the television broadcast display apparatus. In this sense, there is much room for improvement if efficient use of coexisting screens is to be achieved.

### SUMMARY OF THE CLAIMED INVENTION

The present invention solves those problems as mentioned above. A general purpose of the present invention is to provide a technology for efficient use of both the screen of a television broadcast display apparatus and the screen of a mobile device, which coexist with each other, thereby suitably providing information to a user.

In order to resolve these problems, a television broadcast display apparatus according to one embodiment of the present invention comprises: a first screen; a speaker; a mobile device holder; and a control unit. The mobile device holder detachably supports a mobile device having a second screen and capable of outputting audio signals, wherein the mobile device is configured so that an image is displayed on the second screen when the audio signals are outputted there from. The control unit switches between television output status and mobile device output status under a predetermined condition wherein the television output status is a state where the control unit has the first screen display images corresponding to television broadcast signals received and has the speaker output audio corresponding to the received television broadcast signals and the mobile device output status is a state where the control unit has the speaker output audio corresponding to audio signals received from the mobile device mounted. The mobile device holder supports the attached mobile device in such a position that when a user views from a virtual viewing range where the first screen is visible, the second screen is visible there from and that the second screen is located adjacent to the first screen.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a perspective view showing an appearance of a television broadcast display apparatus according to a first embodiment of the present invention;

FIG. 2 is a right side view of a television broadcast display apparatus according to a first embodiment of the present invention;

FIG. 3 is a perspective view showing an appearance of a television broadcast display apparatus with a mobile device installed thereon according to a first embodiment of the present invention;

FIG. 4 is a right side view of a television broadcast display apparatus with a mobile device installed thereon according to a first embodiment of the present invention;

FIG. 5 is a cross-sectional view showing a periphery of a mobile device holder of a television broadcast display apparatus according to a first embodiment of the present invention;

FIG. 6 is a functional block diagram of a television broadcast display apparatus and a mobile device according to a first embodiment of the present embodiment;

FIG. 7 is a perspective view showing an appearance of a television broadcast display apparatus according to a second embodiment of the present invention;

FIG. 8 is a right side view of a television broadcast display apparatus according to a second embodiment of the present invention;

FIG. 9 is a perspective view showing an appearance of a television broadcast display apparatus with a mobile device installed thereon according to a second embodiment of the present invention; and

FIG. 10 is a right side view of a television broadcast display apparatus with a mobile device installed thereon according to a second embodiment of the present invention.

### DETAILED DESCRIPTION

The invention will now be described by reference to the preferred embodiments. This does not intend to limit the scope of the present invention, but to exemplify the invention.

A detailed description is now given of embodiments of the present invention with reference to drawings.

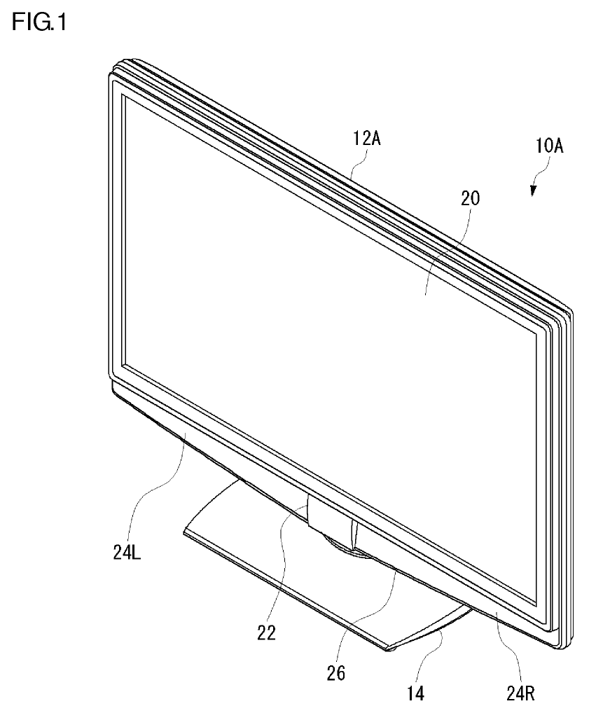

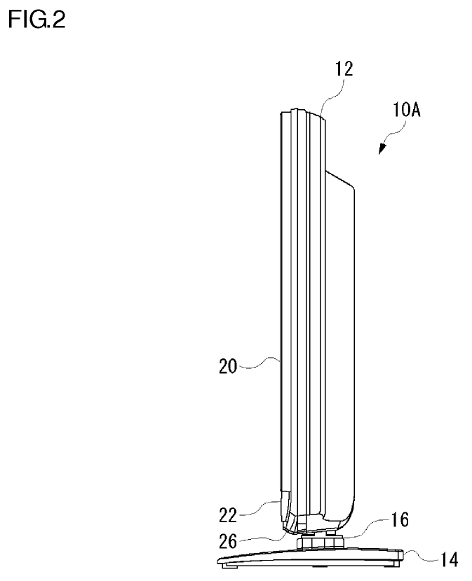

FIG. 1 is a perspective view showing an appearance of a television broadcast display apparatus 10A according to a first embodiment of the present invention. FIG. 2 is a right side view of a television broadcast display apparatus 10A according to the first embodiment. A structure of the television broadcast display apparatus 10A is explained herein referring to both FIG. 1 and FIG. 2.

The television broadcast display apparatus 10A includes a body member 12A, a base member 14, and a coupling support member 16. The body member 12A includes a first screen 20, a right-hand speaker 24R, a left-hand speaker 24L, a cover 26, and a mobile device holder 22. The body member 12A, which has a rectangular shape with a predetermined thickness, has the first screen 20 on one of the faces thereof. The first screen 20 is a slightly smaller in size than the face of the body member 12A and is provided with a frame on its periphery.

The base member 14 is connected to the body member 12A through the coupling support member 16. The base member 14, when placed on a horizontal surface, supports the body member 12A such that the first screen 20 in the longer direction extends horizontally, and that in the shorter direction extends vertically. The side of the television broadcast display apparatus 11A where the first screen 20 is provided will hereafter be called the front face.

The right-hand speaker 24R, having a slender shape, is located at below right of the first screen 20 such that it extends approximately horizontally. The left-hand speaker 24L, having a slender shape, is located at below left of the first screen 20 such that it extends approximately horizontally. In this manner, the right-hand speaker 24R and the left-hand speaker 24L are arranged horizontally side by side underneath the first screen 20. The right-hand speaker 24R and the left-hand speaker 24L are collectively called speakers 24 as appropriate.

The cover 26, which functions as a peripheral member of the first screen 20, constitutes an outer surface of the body member 12A in parts other than the first screen 20 and the speakers 24. The mobile device holder 22 has a form of a rectangular plate. The mobile device holder 22 is attached to the cover 26 between the right-hand speaker 24R and the left-hand speaker 24L such that the long sides thereof are held horizontal.

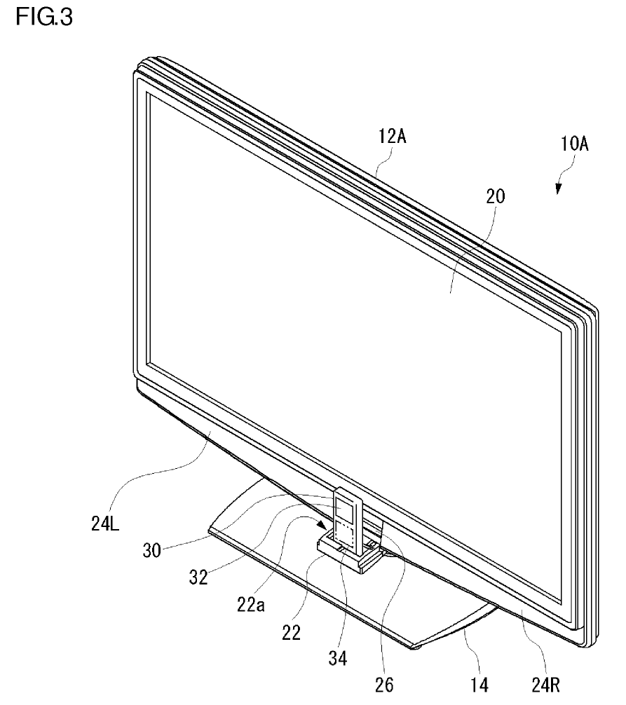

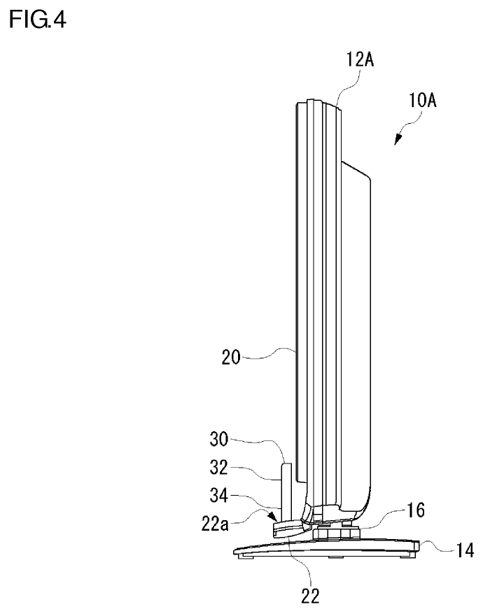

FIG. 3 is a perspective view showing an appearance of the television broadcast display apparatus 10A with a mobile device installed thereon according to the first embodiment of the present invention. FIG. 4 is a right side view of the television broadcast display apparatus 10A with the mobile device installed thereon according to the first embodiment. A structure of the television broadcast display apparatus 10A for installing the mobile device is explained herein referring to both FIG. 3 and FIG. 4.

A mobile device 30, which may come in a substantially rectangular plate form, has a second screen 32 in the upper part and a control panel 34 in the lower part on one face thereof. The mobile device 30 has an attachment unit (not shown) with which it can be installed on other apparatuses. The mobile device 30, which is, for example, a portable music player, is so configured that it can output audio signals to a headphone if it is connected to the headphone jack (not shown) thereof or to another apparatus if it is connected to the attachment unit thereof. When another apparatus is not connected to the attachment unit of the mobile device 30, a user can instruct selection, playback, stop, and the like of music by operating the control panel 34.

The mobile device holder 22 includes a mount 22a to which the mobile device 30 can be attached detachably. The mount 22a is provided rotatably between a first position where the mount 22a is adjacent to the cover 26 and a second position where the upper surface of the mount 22 is open to hold the mobile device 30. Therefore, when the mobile device 30 is not installed, a user can turn the mobile device holder 22 back to the first position, thus having the television broadcast display apparatus assume a desirable appearance without the mobile device holder 22 protruding forward. On the other hand, when the mobile device 30 is to be installed, a user can open the mobile device holder 22 from the first position to the second position and install the mobile device 30 on the mobile device holder 22 by attaching the attachment unit of the mobile device 30 to the mount 22a of the mobile device holder 22.

At this time, the mobile device holder 22 holds and supports the attached mobile device 30 in such a position that when a user views from an expected viewpoint where the first screen 20 is visible, the second screen 32 is also visible there from and that the second screen 32 is located adjacent to the first screen 20. More specifically, the mobile device holder 22 holds the mobile device 30 such that the second screen 32 is located adjacent to the first screen 20 without overlapping with a space projected perpendicularly from the first screen 20. As a result, a user can view the first screen 20 and the second screen 32 at the same time from the same position. Further, the mobile device holder 22 holds the attached mobile device 30 in such a manner that the second screen 32 is held in parallel with the first screen 20. This assures a proper viewing of the second screen 32 by the user who watches the first screen 20.

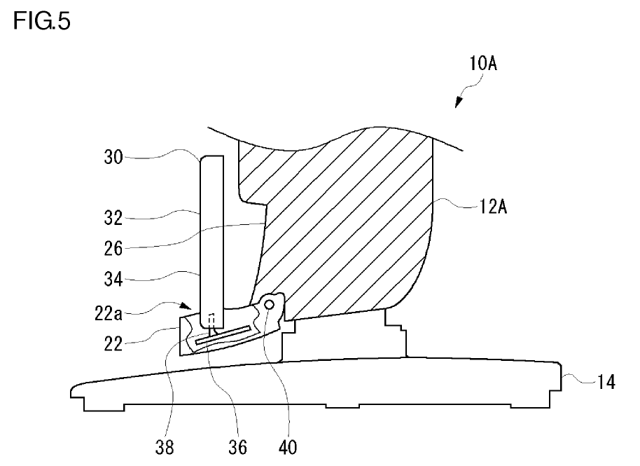

FIG. 5 is a cross-sectional view showing the periphery of the mobile device holder 22 of the television broadcast display apparatus 10A according to the first embodiment of the present invention. As shown in FIG. 5, the mobile device holder 22 is turnably supported by a turning shaft 40 relative to the cover 26.

The mobile device holder 22 incorporates an electronic circuit board 36 which has a connector 38 to which the mobile device 30 is attached. The connector 38 constitutes part of the mount 22a, and as a connector of the mobile device 30 is connected to the connector 38 of the mobile device holder 22, the mobile device 30 is supported by the mobile device holder 22. The connector 38 is a male connector, whereas the connector of the mobile device 30 is a female connector. Accordingly, the connector 38 is provided on the electronic circuit board 36 in such a manner as to protrude from the surface thereof.

The electronic circuit board 36 is so disposed that the second screen 32 is at a slant relative to the surface of the electronic circuit board 36 when the mobile device 30 is connected to the connector 38. In other words, the connector 38 does not protrude from the surface of the electronic circuit board 36 at right angles thereto but at a slant therewith. Since a recess direction of the connector of the mobile device 30 is in parallel with the second screen 32 thereof, the second screen 32 when the mobile device 30 is connected to the connector 38 assumes an inclined position relative to the surface of the electronic circuit board 36. According to the first embodiment, the second screen 32 when the mobile device 30 is connected to the connector 38 is at an angle of 15 degrees with the direction perpendicular to the surface of the electronic circuit board 36. It will be understood by those skilled in the art that the angle is not limited to 15 degrees.

In the first embodiment of the invention, the mobile device holder 22 supports the electronic circuit board 36 in such a position that the second screen 32 and the first screen 20 are in parallel with each other when the mobile device 30 is connected to the connector 38. The mobile device holder 22, when it is in the second position, consequently supports the electronic circuit board 36 with its surface at an angle of 15 degrees from the horizontal surface. There are cases where an apparatus so configured as to hold a mobile device 30 detachably supports the mobile device 30 in such an orientation that the second screen 32 thereof is inclined to face upward. There are cases where a general-purpose electronic circuit board whose connector for connecting the mobile device 30 is at a slant relative to the surface of the circuit board may be used. Thus, the ability to support the electronic circuit board 36 at a slant as described above makes it possible to use such a general-purpose electronic circuit board and at the same time hold the mobile device 30 in such a manner that the second screen 32 and the first screen 20 are in parallel with each other.

It is to be noted that the mobile device holder 22 may hold the mobile device 30 at an angle of the second screen 32 to the first screen 20 in a range of zero to 30 degrees, assuming the angle to be “plus angle” when the second screen 32 faces more upward than the first screen 20. In doing so, the mobile device holder 22 may hold the mobile device 30 at an angle of the second screen 32 to the first screen 20 of about 15 degrees. Note that when the first screen 20 is, for example, ten times or more larger diagonally than the second screen 32, a user, in his/her viewing position, may find it easier to watch the two screens at the same time if the second screen 32 is facing more upward, in a range of zero to 30 degrees, than the first screen 20.

Also, the mobile device holder 22 may be so arranged that the angle of the second screen 32 relative to the first screen 20 when it holds the mobile device 30 can be adjusted. To be more specific, a torque limiter capable of giving a proper amount of friction to the turning of the mobile device holder 22 about the turning shaft 40 may be provided. In such a case, the torque limiter must be such that the turning of the mobile device holder 22 is not caused by a torque given to the turning shaft 40 by the mass of the mobile device 30 but by a predetermined torque larger than the mass of the mobile device 30. By this arrangement, a user can adjust the angle of the second screen 32 for easier viewing from his/her position.

Further, the turning shaft 40 may be provided with a ratchet mechanism. The ratchet mechanism holds the mobile device holder 22 in the second position when it has been turned there from the first position. When the mobile device holder 22 is turned for a predetermined angle from the second position toward the first position, the ratchet mechanism holds the mobile device holder 22 there, restraining the mobile device holder 22 from turning toward the second position. And when the mobile device holder 22 is further turned for a predetermined angle from there toward the first position, the ratchet mechanism holds the mobile device holder 22 in the new position, restraining it from turning toward the second position. Since the ratchet mechanism like this is a known art, the description thereof is omitted here. Thus the arrangement may be such that the angle of the second screen 32 is adjustable by the use of a ratchet mechanism.

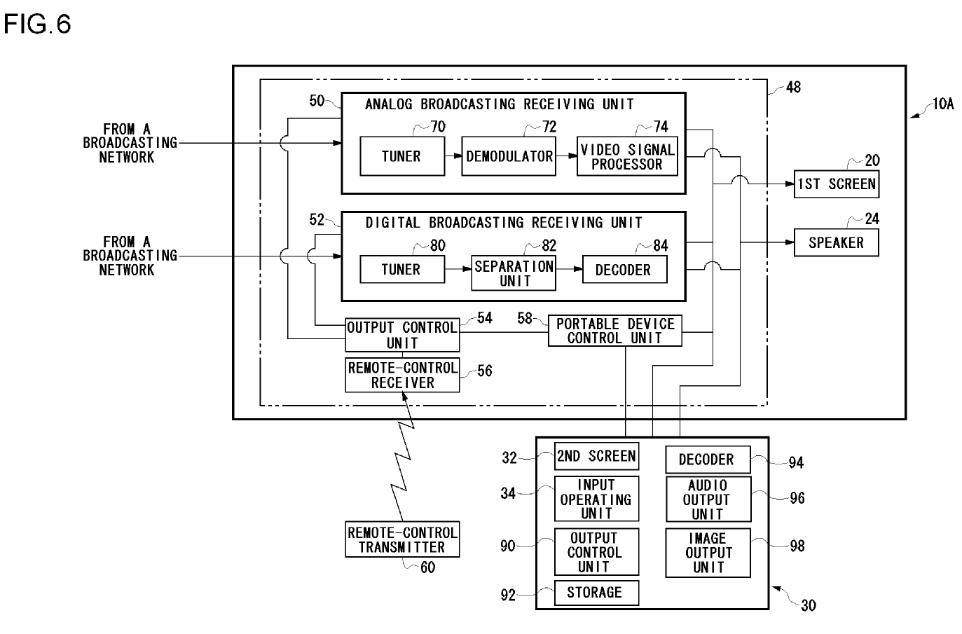

FIG. 6 is a functional block diagram of the television broadcast display apparatus 10A and the mobile device 30 according to first embodiment of the present embodiment. FIG. 6 depicts functional blocks that can be realized by hardware, such as a CPU for executing various arithmetic processing, a ROM for storing various control programs, and a RAM for data storage and used as work area for executing programs, in cooperation with software. Therefore, the functional blocks may be implemented by a variety of manners including hardware only, software only or a combination of both.

The television broadcast display apparatus 10A further includes a control unit 48. The control unit 48 includes an analog broadcast receiving unit 50, a digital broadcast receiving unit 52, an output controller 54, a remote-control receiver 56, and a mobile device controller 58.

The analog broadcast receiving unit 50 includes a tuner 70, a demodulator 72, and a video signal processor 74. The tuner 70 selects a channel from television broadcast signals arriving from broadcast networks by extracting a physical channel signal received in response to the user operation inputted to a remote-control transmitter 60 and performs detection processing on the television broadcast signals of the selected channel. The signals processed by the tuner 70 are supplied to the demodulator 72.

The demodulator 72 demodulates the signals supplied, thereby extracting video signals, audio signals and program-related information. The video signals extracted by the demodulator 72 are supplied to the video signal processor 74. The video signal processor 74 adjusts luminance, color, position and other information on the supplied video signals and outputs the processed video signals to the first screen 20 via a synthesis unit (not shown) which superposes them on the program-related information. The audio signals extracted by the demodulator 72 are outputted to the speakers 24 via an audio processor (not shown).

The digital broadcast receiving unit 52 includes a tuner 80, a separator 82, and a decoder 84. The tuner 70 selects a channel from television broadcast signals arriving from broadcast networks by extracting a physical channel signal received in response to a user operation inputted to a remote-control transmitter 60. The tuner 80 demodulates the television broadcast signals of the selected channel and then supplies them as TS (Transform Stream) format data to the separator 82. The separator 82 separates video data and audio data extracted from the supplied data and supplies the obtained video data and audio data to the decoder 84. The decoder 84 decodes the supplied video data and outputs the obtained video signals to the first screen 20 via the synthesis unit (not shown). The decoder 84 also decodes the supplied audio data and outputs the obtained audio signals to the speakers 24.

The mobile device 30 further includes an output controller 90, a storage 92, a decoder 94, an audio output unit 96, and an image output unit 98 in addition to the second screen 32 and the control panel 34. The storage 92 can store both audio data and video data. The mobile device 30 can reproduce audio data compressed in the MP3 (MPEG Audio Layer-3) format or the AAC (Advanced Audio Coding) format, for instance. The mobile device 30 is also capable of reproducing video data compressed in the MPEG-4 format. And will be understood by those skilled in the art, the audio data and the video data reproducible by the mobile device 30 are not limited to those of the formats mentioned above. The arrangement of the mobile device 30 may be such that the storage 92 may store still image data compressed in the JPEG (Joint Photographic Experts Group) format or the PICT format and have the second screen 32 display such still image data.

The decoder 94 decodes audio data and outputs the decoded audio signals to the audio output unit 96. The audio output unit 96 outputs the obtained audio signals to a connected external unit via a phones jack or a connector. The decoder 94 also decodes video data and outputs the decoded image signals to the image output unit 98. The image output unit 98 outputs the obtained video signals to the second screen 32 or an external device connected thereto via a connector. The outputting of image signals and audio signals by the use of video data is referred to herein as “reproduction or playback of video data.” Likewise, the outputting of audio signals by the use of audio data is referred to as “reproduction or playback of audio data.”

The output controller 90 acquires operation signals resulting from a user operation inputted to the control panel 34 and instruction data received from the mobile device controller 58 provided in the television broadcast display apparatus 10A. The output controller 90 selects data corresponding to the obtained operation signals or instruction data from among a plurality of audio data or video data stored in the storage 92 for example. The output controller 90 also plays back or stops the playback of the data selected corresponding to the obtained operation signals or instruction data. Further, the output controller 90 controls directing output of video signals and audio signals by controlling the image output unit 98 and the audio output unit 96.

The mobile device 30, when it is not connected to an external device via the connector, displays the playback status in a playback screen of audio data or video data on the second screen 32. For example, the mobile device 30, when it is playing back audio data or video data, displays an image indicating that it is playing back audio data or video data or an image indicating the playback time on the second screen 32. The mobile device 30, when it has stopped a playback of audio data or video data, also displays an image indicating a pause or stoppage of playback or the playback time before the pause or stoppage on the second screen 32.

The remote-control receiver 56 receives signals outputted by the remote-control transmitter 60 operated by the user and outputs them, as instruction data corresponding to the user's input operation, to the output controller 54. For example, a user can specify an output source of audio signals or video signals from among the analog broadcast, the digital broadcast, and the mobile device 30 by operating the remote-control transmitter 60. As the remote-control receiver 56 receives instruction signals specifying the output source, the output controller 54 switches the output source of audio signals or video signals to one of the analog broadcast receiving unit 50, the digital broadcast receiving unit 52, and the mobile device 30 based on the instruction data received from the remote-control receiver 56.

When the output source is switched to the analog broadcast receiving unit 50 or the digital broadcast receiving unit 52, images corresponding to the television broadcast signals of the selected channel are displayed on the first screen 20 and sounds corresponding to the television broadcast signals of the selected channel are outputted from the speakers 24. This state is referred to herein as “television output status.”

A user can give instructions to play back or stop playing back the audio data or video data stored in the mobile device 30 by operating the remote-control transmitter 60. As the remote-control receiver 56 receives instruction signals instructing to play back or stop playing back the audio data or video data, the output controller 54 transmits data indicating the instructions to the mobile device controller 58, based on the instruction data received by the remote-control receiver 56. When such data are received, the mobile device controller 58 transmits instruction data instructing a playback or stop of playback to the mobile device 30. The output controller 90 of the mobile device 30 plays back or stops playing back the audio data or video data stored in the storage 92 based on the received instruction data.

When instruction data instructing to play back audio data are received, the output controller 90 of the mobile device 30 plays back the audio data instructed to be played back and outputs the audio signals to a device connected to the mobile device 30. The sounds corresponding to the audio signals outputted thereto are outputted from the speakers 24 of the television broadcast display apparatus 10A. The state in which sounds corresponding to audio data are outputted from the speakers 24 in a playback of the audio data stored in the mobile device 30 will be referred to herein as “first mobile device output status.” The control unit 48 thus switches between television output status and first mobile device output status according to the user operation inputted to the remote-control transmitter 60.

In the first mobile device output status, the mobile device controller 58 receives information indicating the playback status of audio data, such as playback, pause/stop and playback time, from the mobile device 30. Utilizing the received information, the mobile device controller 58 has the first screen 20 display the playback state of audio data as an image. The mobile device controller 58 transmits image data of a logo mark indicating the manufacturer of the television broadcast display apparatus 10A to the mobile device 30. The output controller 90 has the second screen 32 display images corresponding to the received image data. During the playback of audio data stored in the mobile device 30, the first screen 20 displays the playback status of the audio data and the second screen 32 displays an image of the logo mark indicating the manufacturer of the television broadcast display apparatus 10A.

With a television broadcast display apparatus 10A according to the first embodiment of the present invention, the mobile device holder 22 holds the attached mobile device 30 such that the second screen 32 is located adjacent to the first screen 20 without overlapping with a space projected perpendicularly from the first screen 20. As a result, the user can view the playback status of audio data displayed on the first screen 20 and the logo mark indicating the manufacturer of the television broadcast display apparatus 10A displayed on the second screen 32 at the same time. It will be understood by those skilled in the art that the images displayed on the first screen 20 and the second screen 32 during the playback of audio data stored in the mobile device 30 are not limited to those described above.

On the other hand, when instruction data instructing to play back video data are received, the output controller 90 of the mobile device 30 plays back the video data instructed to be played back and outputs video signals and audio signals to the television broadcast display apparatus 10A connected thereto. The output controller 54 has the first screen 20 display images corresponding to the received video signals and has the speakers 24 output sounds corresponding to the received audio signals.

When specifying a playback of video data to the mobile device 30, the mobile device controller 58 transmits instruction data indicating an image display showing the playback status of video data to the mobile device 30. When such instruction data are received, the output controller 90 of the mobile device 30 has the second screen 32 display an image showing the playback status of video data such as playback, pause/stop, and playback time. The state in which images corresponding to video data are displayed on the first screen 20 and sounds corresponding to the video data are outputted from the speakers 24 in a playback of the video data stored in the mobile device 30 are referred to herein as “second mobile device output status.” The control unit 48 switches between television output status and second mobile device output status, according to the user operation inputted to the remote control transmitter 60.

In the second mobile device output status, the user can view the image displayed on the first screen 20 and the playback status video data displayed on the second screen 32 at the same time. As will be understood by those skilled in the art, the images displayed on the first screen 20 and the second screen 32 during the playback of video data stored in the mobile device 30 are not limited to those described above.

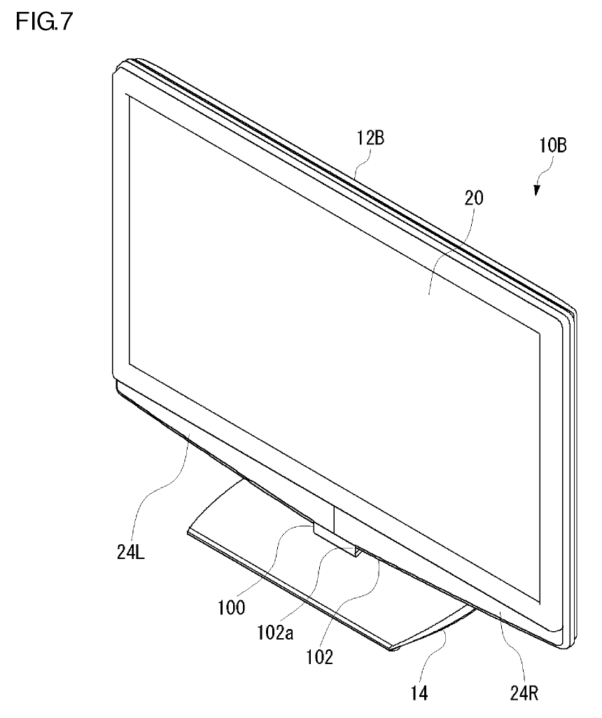

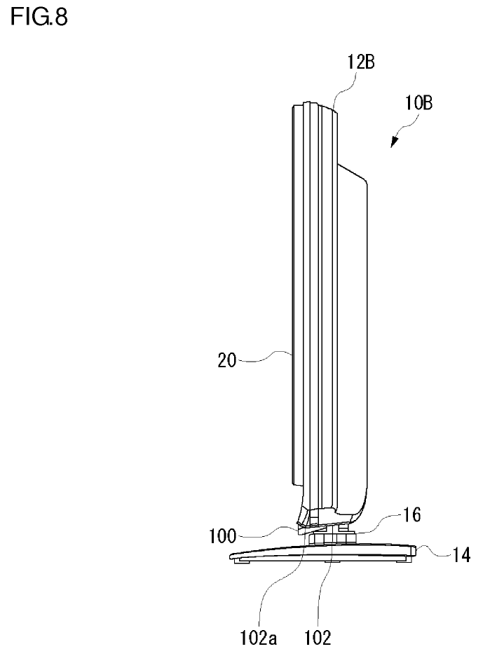

FIG. 7 is a perspective view showing an appearance of a television broadcast display apparatus 10B according to a second embodiment of the present invention. FIG. 8 is a right side view of the television broadcast display apparatus 10B according to the second embodiment. A structure of the television broadcast display apparatus 10B is explained herein, referring to both FIG. 7 and FIG. 8. Note that the same components as those in the first embodiment are denoted with the same reference numerals as those therein, and the description thereof will be omitted.

The television broadcast display apparatus 10B includes a body member 12B, a base member 14, and a coupling support member 16. The body member 12B is the same as the body member 12A except for a mobile device holder 100 and a cover 102, which are provided in place of the mobile device holder 22 and the cover 26, respectively. The mobile device holder 100 has a form of a rectangular plate. A receptacle 102a for receiving the mobile device holder 100 is provided on the cover 102. When the mobile device 30 is not installed, the user can push nearly the whole of the mobile device holder 100 into the receptacle 102a. The position of the mobile device holder 100 stored in the receptacle 102a will be referred to as “first position.”

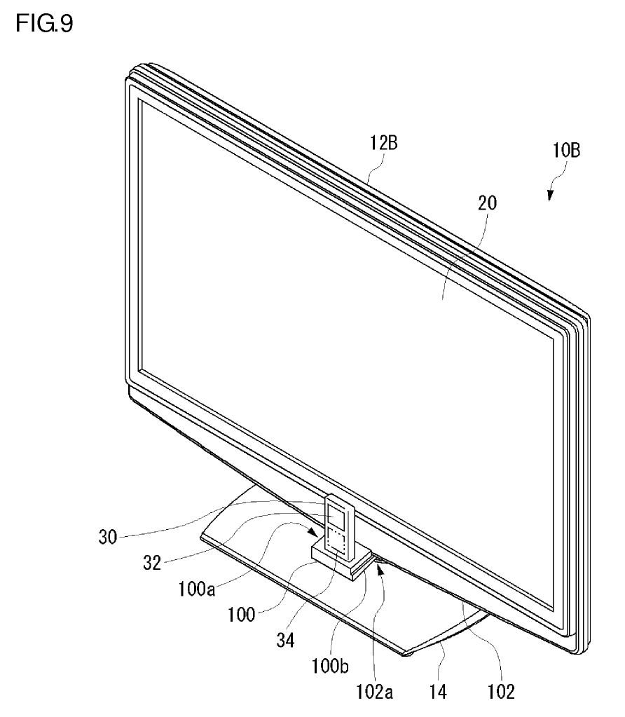

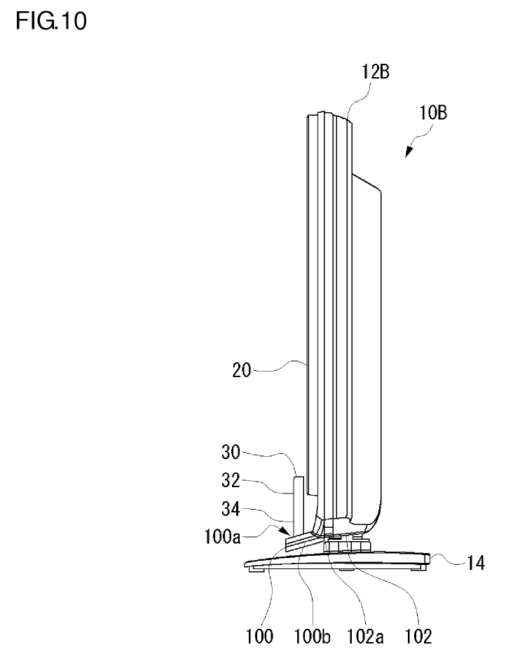

FIG. 9 is a perspective view showing an appearance of the television broadcast display apparatus 10B with a mobile device installed thereon according to the second embodiment of the present invention. FIG. 10 is a right side view of the television broadcast display apparatus 10B with the mobile device installed thereon according to the second embodiment. A structure of the television broadcast display apparatus 10B for installing the mobile device is explained herein referring to both FIG. 9 and FIG. 10. Note that the same components as those in the first embodiment are denoted with the same reference numerals as those therein; the description thereof will be omitted.

The mobile device holder 100 has a mount 100a to which the mobile device 30 is attached. The mobile device holder 100 is provided to move between the first position where the mount 100a, pushed along a guide grooves 100b, is received in the receptacle 102a and the second position where the mount 100a has been pulled out in the direction the first screen 20 faces, that is, to the front of the apparatus so that the mobile device 30 can be attached thereto.

The mobile device holder 100 holds the attached mobile device 30 such that the second screen 32 is located adjacent to the first screen 20 without overlapping with a space projected perpendicularly from the first screen 20. Further, the mobile device holder 100 supports the attached mobile device 30 in such a manner that the second screen 32 is held in parallel with the first screen 20.

The mobile device holder 100 incorporates an electronic circuit board 36, which has a connector 38 to which a mobile device 30 is attached. The mobile device holder 100 supports the electronic circuit board 36 in such a position that the second screen 32 and the first screen 20 are in parallel with each other when the mobile device 30 is connected to the connector 38. The mobile device holder 100, when it is in the second position, consequently supports the electronic circuit board 36 with its surface at an angle of 15 degrees from the horizontal surface. In this manner, the direction in which the mobile device holder 100 is pulled out is approximately in parallel with the slanting direction of the electronic circuit board 36 such that the electronic circuit board 36 disposed therein can be pulled out at a slant.

It is to be noted that in this second embodiment, as in the first embodiment, the mobile device holder 100 may hold and support the mobile device 30 at an angle of the second screen 32 to the first screen 20 in a range of zero to 30 degrees; it may also hold the mobile device 30 at an angle of the second screen 32 to the first screen 20 of about 15 degrees.

The present invention is not limited to the above-described embodiments. Any combination of the above-described structural components as appropriate is effective as and encompassed by the present embodiments. It is understood by those skilled in the art that various modifications such as changes in design may be made based on their knowledge and the embodiments added with such modifications are also within the scope of the present invention. Exemplary modifications will be described herein.

In a modification of the embodiments, as the remote-control receiver 56 receives instruction signals instructing to play back or stop playing back audio data or video data, the mobile device controller 58 transmits instruction data indicating a playback or playback stop to the mobile device 30. When instruction data instructing play back audio data are received, the output controller 90 of the mobile device 30 plays back the audio data instructed to be played back and outputs the audio signals to the connected television broadcast display apparatus. The output controller 54 has the speakers 24 output sounds corresponding to the audio signals received from the mobile device 30 and at the same time has the first screen 20 display images corresponding to the television broadcast signals received by the analog broadcast receiving unit 50 or the digital broadcast receiving unit 52.

When indicating a playback of audio data to the mobile device 30, the mobile device controller 58 transmits instruction data indicating an image display of the playback status of the audio data to the mobile device 30. When such instruction data are received, the output controller 90 of the mobile device 30 has the second screen 32 display an image showing the playback status of the audio data.

The state in which sounds corresponding to audio data are outputted from the speakers 24 in a playback of the audio data stored in the mobile device 30 and, at the same time, images corresponding to the television broadcast signals received are displayed on the first screen 20 will be referred to as “third mobile device output status.” The control unit 48 switches between television output status and third mobile device output status, according to the user operation inputted to the remote-control transmitter 60. In the third mobile device output status, a user can listen to the sounds played back by the mobile device 30 while watching images corresponding to the television broadcast signals on the first screen. At the same time, a user can check on the second screen 32 to see the playback status by the mobile device 30.

In another modification of the embodiments, as the mobile device 30 receives instruction data instructing to play back video data, the output controller 90 plays back the video data instructed to be played back and outputs the audio signals to the television broadcast display apparatus 10A connected thereto. The output controller 54 has the speakers 24 output sounds corresponding to the audio signals received from the mobile device 30 and at the same time has the first screen 20 display images corresponding to the television broadcast signals received by the analog broadcast receiving unit 50 or the digital broadcast receiving unit 52. On the other hand, the output controller 90 does not output the video signals obtained by playing back the video data but has the second screen 32 display images corresponding to the video signals.

The state in which sounds corresponding to video data are outputted from the speakers 24 in a playback of the video data stored in the mobile device 30 and, at the same time, images corresponding to the received television broadcast signals are displayed on the first screen 20 will be referred to as “fourth mobile device output status.” The control unit 48 switches between television output status and fourth mobile device output status, according to the user operation inputted to the remote control transmitter 60. In the fourth mobile device output status, a user can listen to the playback sounds of video data while watching television images displayed on the first screen and playback images of the video data displayed on the second screen 32.

While the embodiments of the present invention and their modifications have been described using specific terms, such description is for illustrative purposes only. It is to be understood that changes and variations may still be further made without departing from the spirit or scope of the appended claims.

What is claimed is:

1. A television broadcast display apparatus, comprising:
a first screen;
a speaker;
a mobile device holder configured to detachably support a mobile device having a second screen and capable of outputting audio signals, wherein the mobile device is configured to display images on the second screen when the audio signals are outputted from the mobile device, and wherein the mobile device holder supports the attached mobile device in such a position that when a user views the first screen from a viewpoint that the second screen is also visible, the second screen located adjacent to the first screen; and
a control unit configured to switch between television output status and mobile device output status under a predetermined condition, wherein television output status is a state where the control unit displays images corresponding to television broadcast signals received on the first screen and outputs audio corresponding to the received television broadcast signals on the speaker, and mobile device output status is a state where the control unit outputs audio corresponding to audio signals received from the attached mobile device on the speaker.

2. The television broadcast display apparatus of claim 1, wherein the mobile device holder supports the attached mobile device such that the second screen is located adjacent to the first screen without overlapping with a space perpendicularly projected from the first screen.

3. The television broadcast display apparatus of claim 1, further comprising a peripheral member disposed adjacent to the first screen, wherein the mobile device holder includes a mount to which the mobile device is attached, the mount rotatably provided between a first position where the mount is adjacent to the peripheral member and a second position where an upper surface of the mount is open to hold the mobile device.

4. The television broadcast display apparatus of claim 1, further comprising a peripheral member including a receptacle to receive the mobile device holder, wherein the mobile device holder includes a mount to which the mobile device, the mount movably provided between a first position where the mount is placed in the receptacle and a second position where the mount is pulled out in a direction the first screen faces.

5. The television broadcast display apparatus of claim 1, wherein the mobile device holder supports the attached mobile device such that the second screen is parallel to the first screen.

6. The television broadcast display apparatus of claim 5, wherein the mobile device holder further comprising an electronic circuit board including a connector to which the mobile device is attached, wherein the electronic circuit board is disposed so that the second screen is at a slant relative to a surface of the electronic circuit board when the mobile device is connected to the connector, and wherein the mobile device holder supports the electronic circuit board such that the second screen is parallel to the first screen when the mobile device is connected to the connector.

7. The television broadcast display apparatus of claim 1, wherein the mobile device holder supports the mobile below the first screen and the mobile device holder supports the mobile device at an angle of the second screen to the first screen in a range of zero to 30 degrees where the angle is a plus angle when the second screen faces more upward than the first screen.

8. The television broadcast display apparatus of claim 1, wherein the mobile device holder is provided such that when the mobile device holder supports the mobile device, the angle of the second screen relative to the first screen is adjustable.

9. The television broadcast display apparatus of claim 1, wherein the speaker includes a pair of speakers that are horizontally arranged in parallel, and wherein the mobile device holder is placed between the pair of speakers.

10. The television broadcast display apparatus of claim 1, wherein the mobile device holder supports a mobile device in a detachable manner, the mobile device being capable of outputting video signals and audio signals corresponding to the video signals to a device connected thereto, and the mobile device being configured such that images are displayed on the second screen when the video signals and audio signals are output there from, and wherein the control unit switches between the television output status and mobile device output status under a predetermined condition, wherein the mobile device output status is a state where the first screen display images correspond to the video signals received from the mobile device and the speaker outputs audio corresponding to the audio signals received from the mobile device.
